(19) United States
(12) Patent Application Publication
(10) Pub. No.: US 2009/0186578 A1
(43) Pub. Date: Jul. 23, 2009

(54) HINGE TYPE BLUETOOTH EAR SET

(75) Inventors: YOUNG HO KIM, Seoul (KR); JOON HO KIM, Yongin-si (KR); JAE HO KANG, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: DREAM TECHNOLOGY CO., Seongnam-si (KR)

(21) Appl. No.: 12/358,013

(22) Filed: Jan. 22, 2009

(30) Foreign Application Priority Data
Jan. 23, 2008 (KR) 10-2008-0007107

(51) Int. Cl. H04B 7/00

(52) U.S. Cl. 455/41.2

(57) ABSTRACT

Disclosed herein is a hinge type Bluetooth ear set. The hinge type Bluetooth ear set has an ear phone hingably connected to a main body of the ear set. An antenna is provided by an antenna pattern formed on an antenna board independent of a main board. The antenna board is connected to the main board at a right angle and disposed in a space between a shaft support supporting the ear phone and an outer surface of the main body. The hinge type Bluetooth ear set has a reduced size of the main board. Further, the hinge type Bluetooth ear set has the antenna board disposed at a lateral side of the hinge shaft, enabling reduction of an overall size of the Bluetooth ear set while ensuring a suitable size of the antenna board.

### CROSS-REFERENCE TO RELATED APPLICATION

The present application claims priority to Korean Patent Application No. 10-2008-7107 filed on Jan. 23, 2008, the entire disclosure of which is incorporated herein by reference.

### BACKGROUND OF THE INVENTION

1. Field of the Invention

The present invention relates to a hinge type Bluetooth ear set that has an ear phone hingably attached thereto. More particularly, the present invention relates to a hinge type Bluetooth ear set that has an antenna board disposed in a clearance space resulting from a hinge structure of an ear phone.

2. Description of the Related Art

In recent years, various kinds of Bluetooth devices have appeared on the market. One such Bluetooth device is an ear set connected to a cellular phone.

FIG. 1 is a perspective view of a conventional hinge type Bluetooth ear set.

Referring to FIG. 1, the hinge type Bluetooth ear set 100 generally has a bar shape. The hinge type Bluetooth ear set 100 includes an ear phone 110 hingably coupled to an upper portion of the ear set 100, and first and second bodies 120 and 130 coupled to each other while supporting the ear phone 110.

In use of the ear set, the ear phone 110 is rotated to be perpendicular to the bodies 120 and 130, and is inserted into the ear of a user.

### SUMMARY OF THE INVENTION

The present invention is conceived to solve the problems of the conventional techniques as described above, and it is an aspect of the present invention to provide a hinge type Bluetooth ear set that has an antenna board disposed independent of the main board to reduce the size of the main board.

In accordance with one aspect of the present invention, there is provided a hinge type Bluetooth ear set having an ear phone hingably connected to a main body of the ear set, wherein an antenna is provided by an antenna pattern formed on an antenna board independent of the main board. The antenna board is connected to the main board at a right angle and disposed in a space between a shaft support supporting the ear phone and an outer surface of the main body.

### BRIEF DESCRIPTION OF THE DRAWINGS

The above and other features and advantages of the present invention will become apparent from the following description of preferred embodiments given in conjunction with the accompanying drawings, in which:

FIG. 1 is a perspective view of a conventional hinge type Bluetooth ear set;

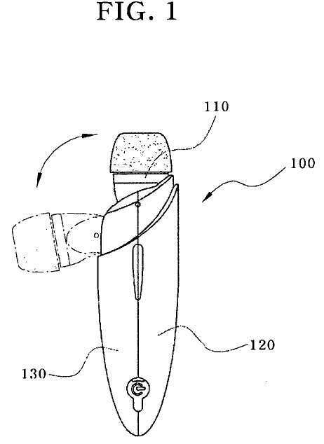

FIG. 2 is an exploded perspective view of a hinge type Bluetooth ear set according to an exemplary embodiment of the present invention;

FIG. 3 is an exploded perspective view of a main board and an antenna board of the hinge type Bluetooth ear set according to the embodiment of the present invention;

FIG. 4 is an assembled perspective view of the main board and the antenna board of the hinge type Bluetooth ear set according to the embodiment of the present invention; and

FIG. 5 is an assembled view of the hinge type Bluetooth ear set according to the embodiment of the present invention, in which an ear phone and the main board having the antenna board attached thereto are assembled to a first body of the ear set.

### DETAILED DESCRIPTION OF THE INVENTION

Exemplary embodiments of the present invention will be described in detail with reference to the accompanying drawings hereinafter.

Herein, the drawings may be exaggerated in thickness of lines or scale of components for the purpose of descriptive convenience and clarity only. Furthermore, terms used herein should be defined in consideration of functions of components of the present invention and thus can be changed according to the custom or intention of users or operators. For convenience of description, structures and operations of the present invention identical to those of conventional techniques will be denoted by the same reference numerals or terms.

Thus, definition of such terms should be determined according to overall disclosures set forth herein.

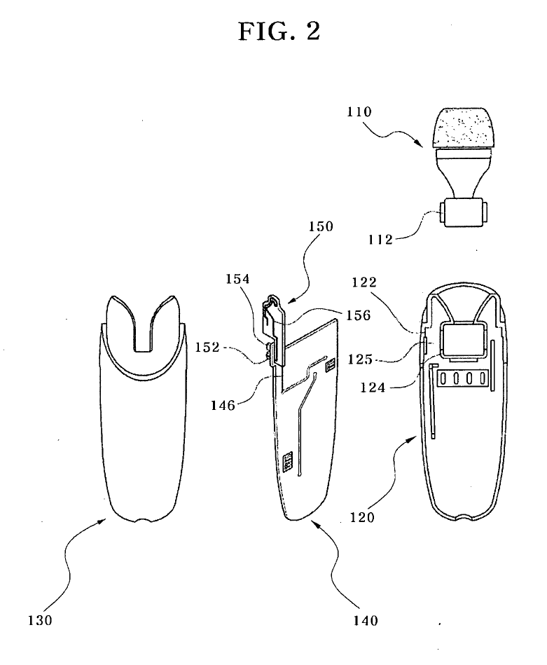

FIG. 2 is an exploded perspective view of a hinge type Bluetooth ear set according to an exemplary embodiment of the present invention.

Referring to FIG. 2, the hinge type Bluetooth ear set includes first and second bodies 120 and 130 constituting an outer appearance of the ear set, an ear phone 110 hingably coupled to the first and second bodies 120 and 130, a main board 140 received inside the first and second bodies 120 and 130, and an antenna board 150 connected to the main board 140.

The first body 120 has an inner space in which the main board 140 can be received, and includes a shaft support 124 for supporting a hinge shaft 112 of the ear phone 110.

The shaft support 124 is protruded in a rib shape and has a predetermined space 125 defined between the shaft support 124 and an outer surface 122 of the first body 120.

According to the embodiment of the present invention, an antenna is formed by the separate antenna board 150, which is independent of the main board 140 and disposed in the space between the outer surface 122 of the first body and the shaft support 124.

Conventionally, the antenna is integrally formed with the main board.

In this case, since it is necessary to provide a space for forming an antenna pattern, there is a problem in that the size of the main board is increased due to the space.

This problem makes size reduction of the ear set difficult. In contrast, according to the present invention, the antenna board is disposed in the space between the outer surface 122 of the first body 120 and the shaft support 124.

The second body 130 is symmetrical to the first body 120 and also defines the space between an outer surface of the second body 130 and the shaft support 130. Thus, a separate description of the second body 130 will be omitted herein.

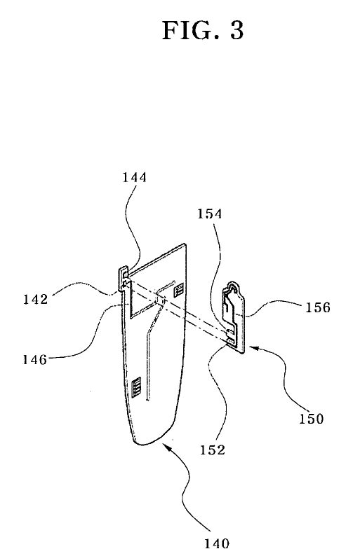

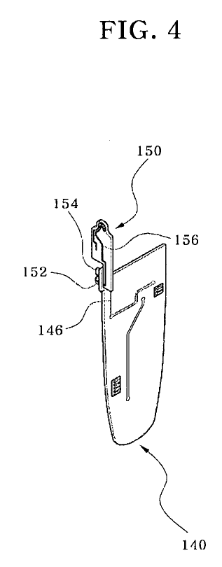

FIG. 3 is an exploded perspective view of the main board and the antenna board of the hinge type Bluetooth ear set according to the embodiment of the present invention, and FIG. 4 is an assembled perspective view of the main board and the antenna board of the hinge type Bluetooth ear set according to the embodiment of the present invention.

Referring to FIGS. 3 and 4, the antenna of the hinge type Bluetooth ear set according to the embodiment of the present invention is formed by an antenna pattern 156 on the antenna board 150, which is independent of the main board 140.

The antenna board 150 has a pair of protrusions 152 and 154, i.e. a first protrusion 152 is connected to the antenna pattern 156 and a second protrusion 156 which is not connected to the antenna pattern 156 and is given for the purpose of rigidly securing the antenna board 150.

The main board 140 has a pair of securing holes 142 and 144 corresponding to the pair of protrusions 152 and 154. A first securing hole 142 is connected to an antenna connection pattern 146 and a second securing hole 144 is provided as a simple hole.

Electrical connection occurs only between the first protrusion 152 and the first securing hole 142, and the second protrusion 154 and the second securing hole 144 serve to prevent rotation of the antenna board 140 in order to ensure more rigid securing of the antenna board 140.

Hence, although the first protrusion 152 is soldered to the first securing hole 142, the second protrusion 154 is secured to the second securing hole 144 merely by insertion of the second protrusion 154 into the second securing hole 144. However, the second protrusion 154 may be secured to the second securing hole 144 by means of bonding agents in order to ensure more rigid securing of the antenna board.

When the antenna board 150 is connected to the main board 140, a plane of the antenna board 150 is orthogonal to that of the main board 140.

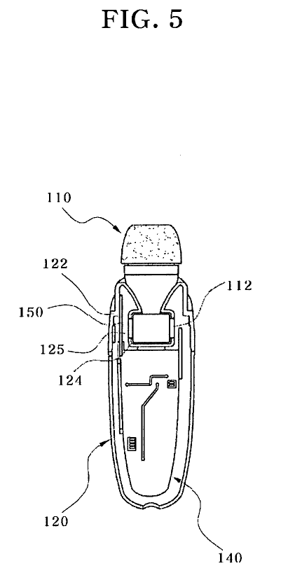

FIG. 5 is an assembled view of the hinge type Bluetooth ear set according to the embodiment of the present invention, in which the ear phone and the main board having the antenna board attached thereto are assembled to the first body of the ear set.

Referring to FIG. 5, when the antenna board 150 assembled to the main board 140 is inserted into the first body 120, the antenna board 150 is disposed in the space between the outer surface 122 and the shaft support 124.

As apparent from the above description, according to the present invention, the hinge type Bluetooth ear set has an antenna board independent of a main board, thereby reducing the size of the main board.

Additionally, according to the present invention, the hinge type Bluetooth ear set has the antenna board disposed at a lateral side of a hinge shaft, enabling reduction of an overall size of the Bluetooth ear set while ensuring a suitable size of the antenna board.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A hinge type Bluetooth ear set having an ear phone hingably connected to a main body of the ear set, wherein an antenna is provided by an antenna pattern formed on an antenna board independent of the main board, the antenna board being connected to the main board at a right angle and disposed in a space between a shaft support supporting the ear phone and an outer surface of the main body.

2. The hinge type Bluetooth ear set according to claim 1, wherein the antenna board has a pair of first and second protrusions and the main board has a pair of first and second securing holes such that the antenna board is secured to the main board by inserting the pair of first and second protrusions into the pair of first and second securing holes, respectively.

3. The hinge type Bluetooth ear set according to claim 2, wherein the first protrusion is connected to the antenna pattern, the first securing hole is connected to an antenna connecting pattern, and the first protrusion is soldered to the first securing hole.

4. The hinge type Bluetooth ear set according to claim 3, wherein the second protrusion is secured to the second securing hole by means of a bonding agent.
